(19) United States
(12) Patent Application Publication
(10) Pub. No.: US 2007/0080279 A1
(43) Pub. Date: Apr. 12, 2007

(54) Device for mounting at least one exhaust pipe of a motor vehicle

(75) Inventor: Giacomo Calandra, Stuttgart, DE (US)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/545,553

(22) Filed: Oct. 11, 2006

(30) Foreign Application Priority Data
Oct. 12, 2005 (DE) 10 2005 048 839.0

(51) Int. Cl. F16M 7/00

(52) U.S. Cl. 248/674

(57) ABSTRACT

A device for mounting at least one exhaust pipe of a motor vehicle to an engine carrier fixed to the vehicle, to which engine carrier an engine mounting is fitted, includes a mounting device that has an exhaust pipe attaching limb attached to the exhaust pipe, and preferably to an attaching device fitted to the exhaust pipe. The device is made easy to fit and inexpensive to manufacture by way of a ramp provided on the mounting device that, in the event of a frontal collision, moves along the engine carrier.

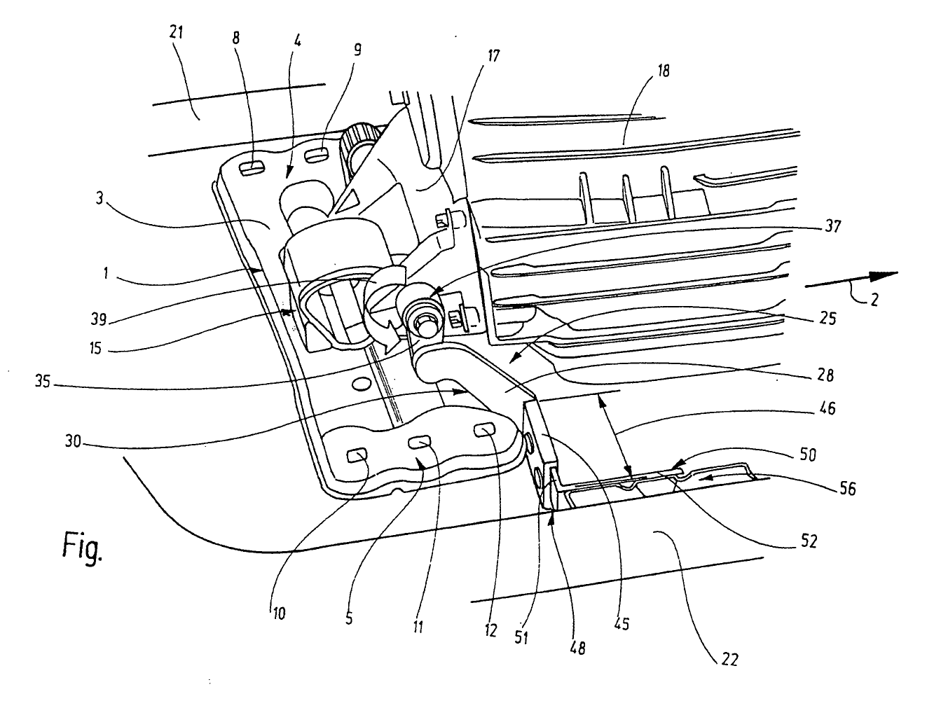

This application claims the priority of German application 10 2005 048 839.0, filed Oct. 12, 2005, the disclosure of which is expressly incorporated by reference herein.

### BACKGROUND AND SUMMARY OF THE INVENTION

This invention relates to a device for mounting at least one exhaust pipe of a motor vehicle to an engine carrier fixed to the vehicle, to which engine carrier an engine mounting is fitted, comprising a mounting device including an exhaust pipe attaching limb that is attachable to the exhaust pipe.

An exhaust system of an engine known from German document DE 103 46 704 A1 has at least one exhaust pipe, and the engine is supported on an engine mounting attached to a crossbeam fixed to the motor vehicle. In the event of a frontal collision, to ensure that the motor/gearbox connection retracts adequately into the transmission tunnel, the mounting has at least one retaining bracket that is fixed to a mounting device of at least one exhaust pipe in such a way that a predetermined break point is defined in the at least one retaining bracket.

German document DE 198 33 160 C2 concerns a device for resiliently mounting an exhaust system on a vehicle that includes a retaining element connected to the vehicle via a connecting device. The retaining element is rotatably mounted in a mounting element. The mounting element is connected to a part of the vehicle. The retaining element is connected to the exhaust system through an intermediate mounting. The retaining element can be rotated relative to the intermediate mounting. The axes of rotation of the retaining element with the mounting element and with the intermediate mounting are arranged in such a way that a pendulum motion of the retaining element in the longitudinal direction of the exhaust system is possible.

From DE 103 135 568 B4, a vehicle is known with an exhaust system support for mounting the exhaust system. The exhaust system support has a supporting element in the form of a laminated bracket.

From DE 192 32 349 C2, an exhaust system is known that includes a supporting device which is fitted with resilient elements and engages at various points on the wall of a silencer.

One object of the invention is to provide a device of the type referred to initially that is easy to fit and inexpensive to manufacture.

A device according to the invention thus includes a ramp provided at the mounting device so that, in the event of a frontal collision, it moves along the engine carrier. Due to the ramp, movement of the mounting device relative to the engine carrier is enabled in a simple manner. In particular, wedging or jamming of the mounting device is prevented.

In a preferred exemplary configuration of the device, the ramp is formed on a retaining bracket from one end of which the exhaust pipe attaching limb extends. The retaining bracket is connected to the exhaust pipe attaching limb to form a single piece.

In a further preferred exemplary configuration of the device, the retaining bracket is arranged inclined to a horizontal plane in the longitudinal direction of the vehicle with the motor vehicle in normal operation. The horizontal plane extends parallel to the floor of the motor vehicle.

In a further preferred exemplary configuration of the device, the exhaust pipe attaching limb is arranged essentially transverse relative to the longitudinal direction of the vehicle. This ensures that the retaining bracket can move in its longitudinal direction, or in the longitudinal direction of the vehicle, in the event of a frontal collision.

In a further preferred exemplary configuration of the device, the exhaust pipe attaching limb has a length of approximately 10 cm. This length has proved particularly advantageous in the context of this invention.

In a further preferred exemplary configuration of the device, a gearbox attaching limb fitted to a gearbox carrier, that in turn is mounted on the engine mounting, extends from the other end of the retaining bracket. The gearbox attaching limb is connected to the retaining bracket to form a single piece.

In a further preferred exemplary configuration of the device, the gearbox attaching limb is fitted to the gearbox carrier in such a way that the gearbox attaching limb can rotate about a rotary axis in the event of a frontal collision. Due to this, the retaining bracket can perform an upwards swivelling motion in the event of a frontal collision.

In a further preferred exemplary configuration of the device, the rotary axis runs essentially transverse to the longitudinal direction of the vehicle. This enables a pendulum motion of the retaining bracket.

In a further preferred exemplary configuration of the device, the gearbox attaching limb extends in an essentially vertical direction with the motor vehicle in normal operation. In this case, “vertical” means perpendicular with respect to the floor of the vehicle.

In a further preferred configuration of the device, each of two retaining brackets, as previously described, is attached both to the gearbox carrier and to an exhaust pipe, and preferably to an attaching device fitted to the exhaust pipe.

Further advantages, features and details of the invention are set forth in the following description, in which an exemplary embodiment is described in detail with reference to the drawing. Furthermore, the features mentioned in the claims and in the description can be used in the invention either individually or in any combination.

### BRIEF DESCRIPTION OF THE DRAWING

The single FIGURE is a perspective view of an exemplary embodiment of a device according to the invention.

### DETAILED DESCRIPTION OF THE INVENTION

The FIGURE shows a device for mounting an exhaust system of the motor vehicle. A rear engine carrier 1 is arranged transverse to a longitudinal direction of the vehicle as shown by arrow 2. The rear engine carrier 1 is therefore designated as crossbeam 3. Crossbeam 3 has two side areas 4 and 5 that are provided with several through holes 8, 9; 10 to 12. The through holes serve to attach the rear engine carrier 1 to a supporting structure (not illustrated) of the motor vehicle.

An engine mounting 15 is fitted to the top of the rear engine carrier 1. A gearbox carrier 17 is mounted on the engine mounting 15. A gearbox 18 of the motor vehicle is then attached to the gearbox carrier 17. Two exhaust pipes 21, 22 of an exhaust system of the motor vehicle run along the side of the gearbox 18 and the rear engine carrier 1. The exhaust pipes 21, 22 run essentially in the longitudinal direction of the vehicle.

The two exhaust pipes 21, 22 are attached to the gearbox carrier 17 by means of two mounting devices, of which only one mounting device 25 is shown in the illustration. The two mounting devices are of similar construction. The construction and functioning of the visible mounting device 25 are explained in the following.

The mounting device 25 has a retaining bracket 28 that is arranged at an incline relative to the floor of the motor vehicle in the longitudinal direction of the vehicle. A ramp 30, arranged at a distance from the front edge of the rear engine carrier 1, is formed on the retaining bracket 28. A gearbox attaching limb 35 that runs essentially vertical relative to the floor of the motor vehicle is formed on one end of the retaining bracket 28. The gearbox attaching limb 35 is connected to the retaining bracket 28 to form a single piece. The free end of the gearbox attaching limb 35 is attached to a mounting point 37 on the gearbox carrier 17. In the event of a frontal collision, the mounting point 37 enables a rotary motion of the gearbox attaching limb 35 about an axis that is transverse, or essentially transverse, with respect to the longitudinal center axis of the vehicle, as shown by arrow 39.

From the other end of the retaining bracket 28, an exhaust pipe attaching limb 45 extends transverse to the longitudinal direction of the vehicle. The exhaust pipe attaching limb 45 has a length 46 of 10 cm and is joined to an attaching device 48 by attaching means such as bolts or rivets. The attaching device 48 includes an angle bracket 50 with two legs 51, 52. The exhaust pipe attaching limb 45 is attached to leg 51. Leg 52 of the angle bracket 50 is attached to an intermediate mounting 56 that is in turn attached to the exhaust pipe 22.

By means of the pendulum-type construction and the geometry of the mounting device 25, the retaining bracket 28 is rotated when the gearbox 18 moves rearwards, i.e. in the longitudinal direction of the vehicle. As a result of the ramp 30 which forms a sloping plane at the retaining bracket 28, the latter is also rotated upwards. Due to the Z-shape of the mounting device 25, as viewed in the longitudinal direction of the vehicle, said mounting device 25 is pulled straight in the event of a frontal collision. Further travel can thus be enabled.

In the event of a frontal collision, the gearbox is pushed rearwards. During a movement of this kind, the engine mounting 15 is deformed. The ramp 30 at the retaining bracket 28 moves against the front edge of the rear engine carrier 1. A rotary motion in the direction of arrow 39 is enabled by the mounting point 37 on the gearbox carrier 17. The ramp 30 slides along the engine carrier 1. The transverse exhaust pipe attaching limb 45 enables the retaining bracket 28 to move in the longitudinal direction of the vehicle. According to an essential aspect of this invention, the mounting device 25 enables a rearward movement of the gearbox 18. This movement is not retarded by the mounting device 25.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

I claim

1. A device for mounting at least one exhaust pipe of a motor vehicle to an engine carrier fixed to the vehicle, to which engine carrier an engine mounting is fitted, comprising a mounting device including an exhaust pipe attaching limb that is attachable to the exhaust pipe, wherein a ramp is provided at the mounting device that, in the event of a frontal collision, is movable along the engine carrier.

2. The device according to claim 1, wherein the attaching limb is attachable to an attaching device fitted to the exhaust pipe.

3. The device according to claim 1, wherein the ramp is formed on a retaining bracket from one end of which the exhaust pipe attaching limb extends.

4. The device according to claim 3, wherein the retaining bracket is arranged inclined to a horizontal plane in the longitudinal direction of the vehicle with the motor vehicle in normal operation.

5. The device according to claim 1, wherein the exhaust pipe attaching limb is arranged essentially transverse relative to the longitudinal direction of the vehicle.

6. The device according to claim 5, wherein the exhaust pipe attaching limb has a length of approximately 10 cm.

7. The device according to claim 3, wherein a gearbox attaching limb fitted to a gearbox carrier, that in turn is mounted on the engine mounting, extends from the other end of the retaining bracket.

8. The device according to claim 7, wherein the gearbox attaching limb is fitted to the gearbox carrier in such a way that the gearbox attaching limb can rotate about a rotary axis in the event of a frontal collision.

9. The device according to claim 8, wherein the rotary axis runs essentially transverse to the longitudinal direction of the vehicle.

10. The device according to claim 8, wherein the gearbox attaching limb extends in an essentially vertical direction with the motor vehicle in normal operation.

11. The device according to claim 3, wherein the retaining bracket is one of two retaining brackets, each of which is attachable both to the gearbox carrier and to an exhaust pipe.

12. The device according to claim 11, wherein each of the two retaining brackets is attachable to an attaching device fitted to the exhaust pipe.

13. The device according to claim 2, wherein the exhaust pipe attaching limb is arranged essentially transverse relative to the longitudinal direction of the vehicle.

14. The device according to claim 3, wherein the exhaust pipe attaching limb is arranged essentially transverse relative to the longitudinal direction of the vehicle.

15. The device according to claim 4, wherein the exhaust pipe attaching limb is arranged essentially transverse relative to the longitudinal direction of the vehicle.

16. The device according to claim 13, wherein the exhaust pipe attaching limb has a length of approximately 10 cm.

17. The device according to claim 14, wherein the exhaust pipe attaching limb has a length of approximately 10 cm.

18. The device according to claim 15, wherein the exhaust pipe attaching limb has a length of approximately 10 cm.

19. The device according to claim 4, wherein a gearbox attaching limb fitted to a gearbox carrier, that in turn is mounted on the engine mounting, extends from the other end of the retaining bracket.

20. The device according to claim 9, wherein the gearbox attaching limb extends in an essentially vertical direction with the motor vehicle in normal operation.
